(19) United States
(12) Patent Application Publication
(10) Pub. No.: US 2011/0045299 A1
(43) Pub. Date: Feb. 24, 2011

(54) METHOD FOR PRODUCING STABLE, MONODISPERSED, NANOMETRIC MAGNESIUM HYDROXIDE AND RESULTING PRODUCT

(75) Inventor: Jesús Manuel Martínez, Nuevo Leon (MX)

Correspondence Address: FSB FisherBroyles, a Limited Liability Partnership, The Pinnacle Building, 3455 Peachtree Road, NE Fifth Floor, Atlanta, GA, 30326, US

(73) Assignee: SERVICIOS INDUSTRIALES PENOLES ,S.A. DE C.V.

(21) Appl. No.: 12/443,835

(22) PCT Filed: Apr. 3, 2007
(86) PCT No.: PCT/MX2007/000045

§ 371 Date: Jun. 11, 2010

(30) Foreign Application Priority Data
Oct. 3, 2006 (MX) NL/A2006/000070

(51) Int. Cl. C01F 5/14

(52) U.S. Cl. 428/402; 423/638; 423/637; 423/635

(57) ABSTRACT

The present invention refers to a method to prepare nanometric magnesium hydroxide particles. These particles have an average diameter that ranges from 90 to 110 nm, and that could range from 20 to 160 nm, with monodisperse and stable characteristics for greater than 12 month in a wide range of concentrations. This process includes 3 stages: one reaction stage performed in two steps, one of maturation and one of purification. The first step of the reaction is developed in micro blending zone, and the second one is the stabilization of suspension. During the second stage, the particles maturation is developed through a chemical-mechanic treatment. The last stage is designed to purify and concentrate the material, as well as its preparation to integrate it to the desired form. The obtained particles are re-dispersable in different means, such as water, aldehyde resins, phenolic resins, nitrocellulose, polyurethane, vinylic, acrylic, alcohol, and wide variety of organic materials and polymers such as high and low density polypropylene, Nylon, ABS and/or any combination of the same

### FIELD OF THE INVENTION

The present invention is related to the process of the preparation of nanoparticles and specifically, to the process of preparing the nanoparticles of monodisperse and stable magnesium hydroxide that is dispersible in different environments.

### PRECEDENTS TO THE INVENTION

Magnesium Hydroxide is used for many different purposes, such as: neutralizer of waste water acids in industrial processes; pH controller; stabilizer of stomach acids; flame resistance and suppressor of smoke for the Polymer industry in different applications.

To avoid confusion in the use of certain terms, in the present text, the term “nanoparticle” is generally used to refer to particles that have a diameter equal to or less than 100 nm, and the term “monodispersion” is used to identify particles with a uniform size in a phase of dispersion.

It is known that the properties and functions of nanometric materials, in this case magnesium hydroxide should be studied for the benefit of society.

The processes of the fabrication of magnesium hydroxide are well known and industrially exploited, as an intermediate product, primarily in the production of flame resistant materials. The oxides are hydrated producing suspensions of magnesium hydroxide whose particle sizes can fluctuate from 0.05 to 10.0 microns. It is obvious that this material cannot be considered nanometric or stable. In this application, in particular, it is desirable to fabricate particles in closed range distribution and large sizes, so that it eases the elimination of impurities (bleach, boron, calcium, iron) in the final product.

Differences have been found in the way to characterize the nanometric product. The size of the particles or of the crystals can be measured. Measuring the crystals can be done by taking as the base the width and the profile of the points of the diffractogram and evaluating these parameters with the Rietveld method; or with the help of a (transmission or scanning) electron microscope and measuring the crystals that are within the observation field. Measuring the size of the particle can be done with the dispersion of light, the dispersion of phototons, the attenuation of acoustic waves and measuring the velocity of sedimentation. Another technique for the characterization of the particles is the measurement of the surface area and taking into account the morphology of the crystals, to make an estimate of the size that it would have to obtain such surface area.

The measurement of the size of a particle, different from the measurement of the size of the crystal, is that the first reflects the distribution of the real size that a material has in a given state.

In our case, we used the dispersion of a laser ray (dispersion of light) in the product obtained by the method of the present invention.

In patent number CN1332116, for the preparation of the nanoparticles of magnesium hydroxide, the process should take place at a temperature of between 100 and 200° C., with a reaction time being between 2 and 12 hours.

In patent number CN341694, the reaction takes place in the rotary bed. The temperature of maturation needs to be between 80 and 100° C.

In patent number CN1359853, it doesn't give details as to the way that the reaction is to take place, the surfactant additives used are potassium salt and OP-10; the product obtained requires a trituration to obtain the dispersion, furthermore, the reported size is that of a crystal measured by the diffraction of x rays (DRX by its acronym in Spanish).

In patent number CN1361062, the reactor used is of a previously mixed liquid membrane.

In patent number CN1389521, the reaction takes place in only one phase in a reactor with high velocity agitation, then follows the process of 5 hours of ultrasound, then the gelatin formed dries and proceeds to a stage of grinding.

### OBJECTIVE OF THE INVENTION

Upon the light of the problems found in the previous art, it is the purpose of the present invention, to provide a new process for the preparation of nanoparticles of magnesium hydroxide.

An additional objective of the invention is to prove a process for the production in high concentrations of the nanoparticles of magnesium hydroxide.

Another objective of the present invention is that the process permits the production of monodisperse particles of magnesium hydroxide.

One more objective of the invention is that the nanoparticles of the magnesium hydroxide that are obtained through the process will have diameters between 90 and 110 nm.

Another objective of the invention is that the nanoparticles produced through the process offer a superior stability to 12 months, without agitation during the period of storage.

One more objective of the invention is to provide a process for the production of nanoparticles of magnesium hydroxide in a pattern of batches.

Another objective of the invention is to provide a process for the production of nanoparticles of magnesium hydroxide in a continuous pattern.

One more objective of the invention is that the process of the production of the hydroxide in the process permits the control of the size of the particle.

Another objective of the invention is that the product will have properties to disperse in different substances.

### A BRIEF DESCRIPTION OF THE FIGURES

For a better understanding of the material of the invention, the description is accompanied by a series of figures that are to be illustrations and not limiting to the reach of the same. They are described in the following.

Figure one is a diagram of the blocks of the process for obtaining the nanoparticles of magnesium hydroxide from the invention.

Figure two is a graph of the size distribution of the particles of magnesium hydroxide obtained from the invention's process.

Figure three is a graph of the size distribution of the particle of magnesium hydroxide obtained from the invention's process.

Figure four is a micrograph of the nanometric and monodisperse magnesium hydroxide with particle sizes between 20 and 50 nm, prepared for the procedure described of the present invention.

Figure Five is a diffractogram of magnesium hydroxide obtained through the present invention.

### A BRIEF DESCRIPTION OF THE INVENTION

The present invention is related with the method of preparation of the nanometric particles of magnesium hydroxide that have a diameter in the range of 20 to 160 nm with an average diameter of 100 nm. The particles have the characteristics of monodisperse particles and a stability of greater than 12 months and are found in a wide range of concentrations.

The process of the present invention takes place starting from the controlled quantities of magnesium salts, such as chlorides, sulfates, acetates, oxides, magnesium carbonate, and others, as well as combinations of the same, that following is to maintain a pH control by the controlled addition of alkalis, such as sodium carbonate, potassium carbonate, sodium hydroxide, potassium hydroxide, ammonium, and ammonium solutions, with that which causes the precipitation of magnesium hydroxide.

The process takes place in 3 stages: a reaction realized in 2 steps, a stage of development and a stage of purification. The first step of the first stage of the reaction is characterized by a micro mixed reaction zone, where the size of the particle is controlled and with the integration of additives assures the monodispersion of the particles; the second step of the reaction is the stabilization of the suspension. In the second stage, the development of the particles is established trough a chemical-mechanical process. The last stage is designed for the purification and the concentration of the material, as well as the preparation of the same into the desired state, giving it stable and disperse properties.

The particles are able to be re-dispersed into different forms, such as water, alcohols, aldehyde resins, phenolic resins, polyurethane, vinyl, acrylics, and in a wide variety of organic materials and polymers such as high and low density polypropylene, Nylon, ABS and/or any combination of the same.

### DETAILED DESCRIPTION OF THE INVENTION

Following are the details of the procedure of the invention, the same that is illustrated in Figure one, in which the operations and the currents are described as indicated by the numbers in parenthesis.

### Stage 1. Reaction (600)

### Preparation of the Aqueous Magnesium Solution (100)

The aqueous magnesium solution can contain from 0.01% to 10% weight of the dissolved magnesium, that is obtained from a source of magnesium (10) selected from the group made up of chlorides, sulfates, acetates, oxides, magnesium carbonate, and others, as well as mixes of the same. A surfactant (30) that is selected from the group that includes ethoxylates (like nonylphenol), alkyl phenol ethoxylate, and sodium laureth sulfate, in a quantity from 0.01% to 10% and preferable 3% in the base of the weight of the precipitated magnesium hydroxide, is added. Also in this aqueous solution, an organic acid (20) selected from the group that includes succinic, ascorbic, oxalic, adipic, tartaric, citric, diglycolic, salcylic and glutaric acids, as well as other types of acids is desolved, in a quantity of from 0.01% to 10% and preferable 2% in base weight of the magnesium hydroxides that has precipitated.

### Preparation of the Aqueous Alkali Solution. (200)

A aqueous alkali solution in a concentration of up to 50% of the weight of an alkali (40) is selected from the group that includes sodium and potassium carbonates, ammonia, sodium, potassium, calcium hydroxides, ammonium solutions and other alkalis that allow the pH in a reaction to increase to values higher than 8.5. To this aqueous solution is added a dispersant (50) with a acrylate polymer base, such as GBC-110; Disperbyk® 190, 185 y 156 (Byk Chemie); Busperse® 39 (Beckman); among others, from 0.01% to 10% of the base weight of the magnesium hydroxide precipitate.

### Preparation of the Aqueous and Diluted Solution of the Reaction.

The aqueous diluted solution contains water (60) and a dispersant (70) with an acrylate polymer base with up until 10% of the base the weight of the magnesium hydroxide precipitate.

Reaction of the Creation of Nanometric Magnesium Hydroxide (600).

The reaction (600) can take place in batches as well as continuously, depending on the scale of the production that is required to obtain, but in all cases it is defined in two steps.

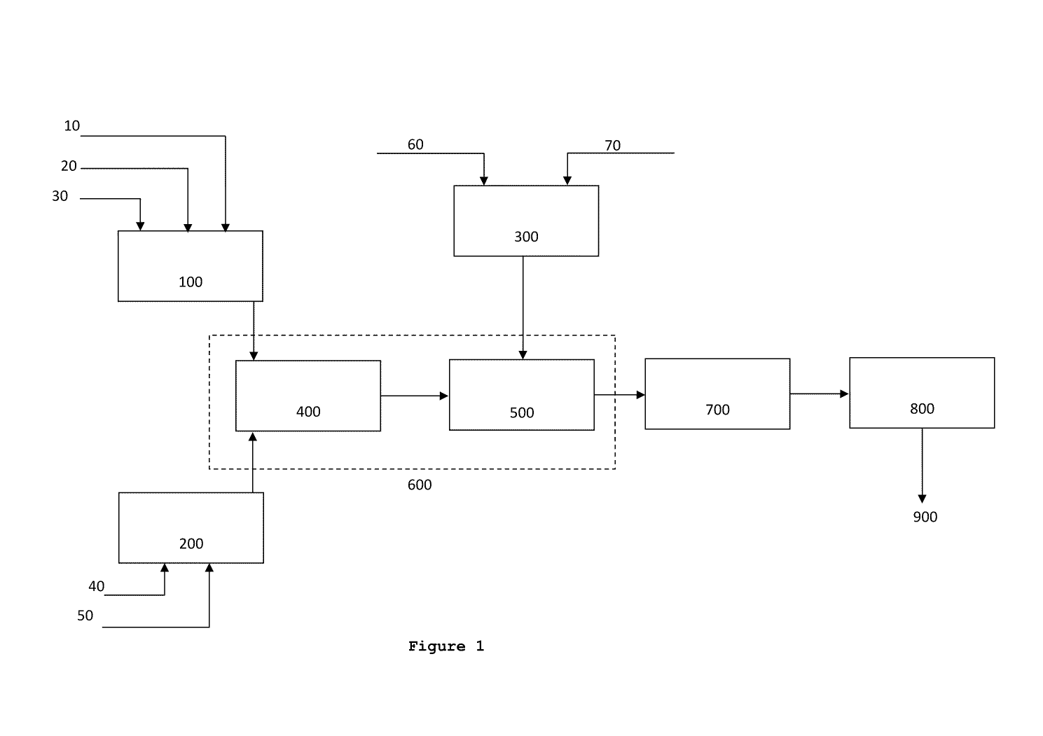

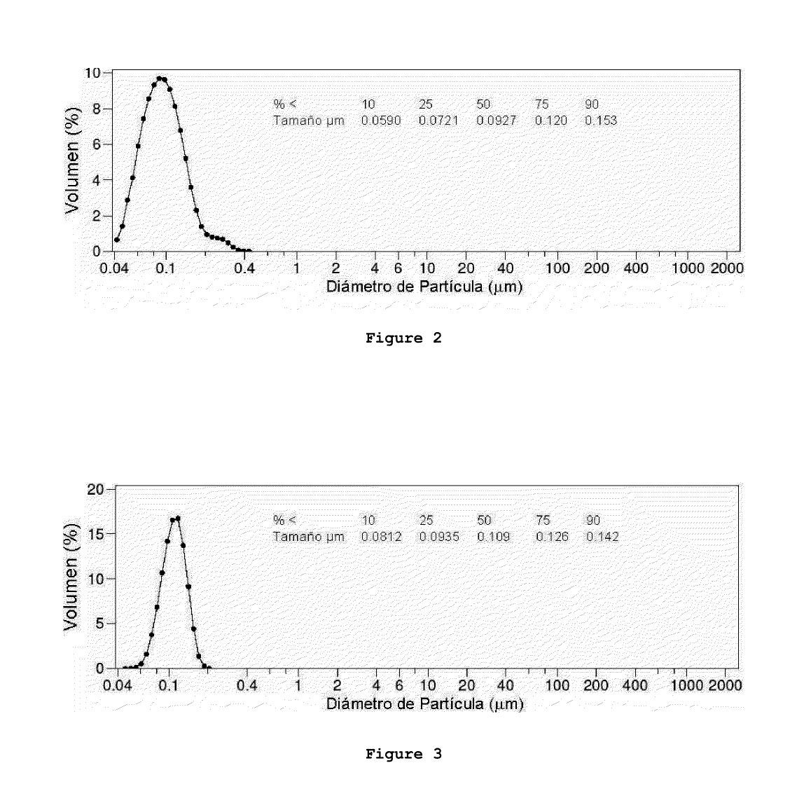

The FIGS. 2, 3, 4 and 5 are the results of the analysis of the productions done in a (semi-industrial) pilot plant with a capacity of 1.0 tons per day of nanometric magnesium hydroxide.

In the micro mixing zone (400) the solutions of magnesium (100) and alkali (200) are combined. The proportion between the magnesium (100) and the alkali (200) can be in figured according to the rules of stoichiometry, or with an excess of from 20 to 50% in excess of either one of the reactants, preferable in excess of the alkali.

It is important to state that in the absence of additives and in stoichiometric quantities, the reaction produces magnesium hydroxide with crystals and large particles and a low surface area; the excess of any of the reactants produces Mg(OH)₂ in the form of small crystals, with large particles, and large surface areas of approximately 60 m2/g or more. With the use of additives that conform with the invention, and especially with an excess of 30% of alkali, small crystals and small particles are produced, and a surface area of approximately 60 m2/g or more is obtained.

The time of residence in the micro mixer can be up to 3 minutes, and preferably less than a minute. The conditions of the micro mixing zone are a turbulent flow, with Reynolds number NRe of 3,000 or greater. The temperatures of operation in the micro mixing zone are found to be between 5° and 45° C.

In the stabilization zone (500) of the suspension, that can be provided by an internal accessory of the reactor as well as by external equipment, is added the aqueous diluted solution (300) assuring that the conditions of the mixture are homogenous, such that a pumping range of at least 2 and a maximum of 6 prevails, that is the massive velocity of fluid should be at least 10 ft/min. till 40 ft/min.; the time of residence in the order for 5 to 30 minutes, and preferable between 5 and less than 10 minutes, although the agitation can be maintained for up to 3 hours.

It is important that during the reaction (600) that a pH of 8.5 or higher is maintained.

### Stage 2. Maturation of the Nanometric Magnesium Hydroxide (700)

The process of maturation implies a mechanical and chemical conditioning, with the application of ultrasound through any conventionally available means, using a frequency in the range of 20 to 45 kHz in a way that the action combined with mechanical work and the dispersants and organic acids, allows the deactivation of the active points, although they are still present in the particles and crystals of the formed hydroxide. The maturation period has a maturation time less than or equal to 3 hours, and preferable between 15 and 60 minutes. The temperature at this stage should be controlled at between 60 and 80° C.

### Stage 3. Washing the Nanometric Magnesium Hydroxide (800)

The stage of washing (800) serves to purify the magnesium hydroxide produced in the stages of reaction (600) and maturation (700), and is shaped by as many cycles as is required until reaching the purity established, concentrating the product until a paste is obtained that has contents of up to 35% solid, and in special conditions it can reach 60%, being the redispersible magnesium hydroxide with a particle size of between 90 and 110 nm.

The product obtained in this way is magnesium hydroxide with the particle size distribution being as is shown in FIGS. 2 and 3, where FIG. 2 is a graph of the distribution of the particle sizes of magnesium hydroxide obtained by the process of the invention, in a (semi-industrial) pilot plant with a capacity of 1.0 tons per day of nanometric magnesium hydroxide, where the following distribution of particle sizes are shown: D10, 59.0 nm; D50, 92.7 nm; D90, 153 nm, measured by the diffraction of laser rays in the equipment marked with brand name “Coulter L5230”, showing a crystal size of 23 nm, measuring the width as the base and the profile of the points of the (diffractogram), obtained from the diffractometer of X rays brand named “Bruker D8 Advance” and evaluating these parameters with the Rietveld method.

The FIG. 3 graphically shows magnesium hydroxide particle size distribution obtained by this invention process, in a (semi industrial) pilot plant with capacity of 1.0 Tons per day of nanometric magnesium hydroxide, where the following particle size distribution is shown: D₁₀, 81.2 nm; D₅₀, 109 nm; D₉₀, 142 nm. All of them were measured by laser ray diffraction, using a COULTER L5230 device, with a crystal size of 24 nm measured by using as the base the width and the profile of diffractogram peaks, which are obtained using BRUKER D8 Advance x ray diffractometer, and evaluating these parameters using Rietveld method.

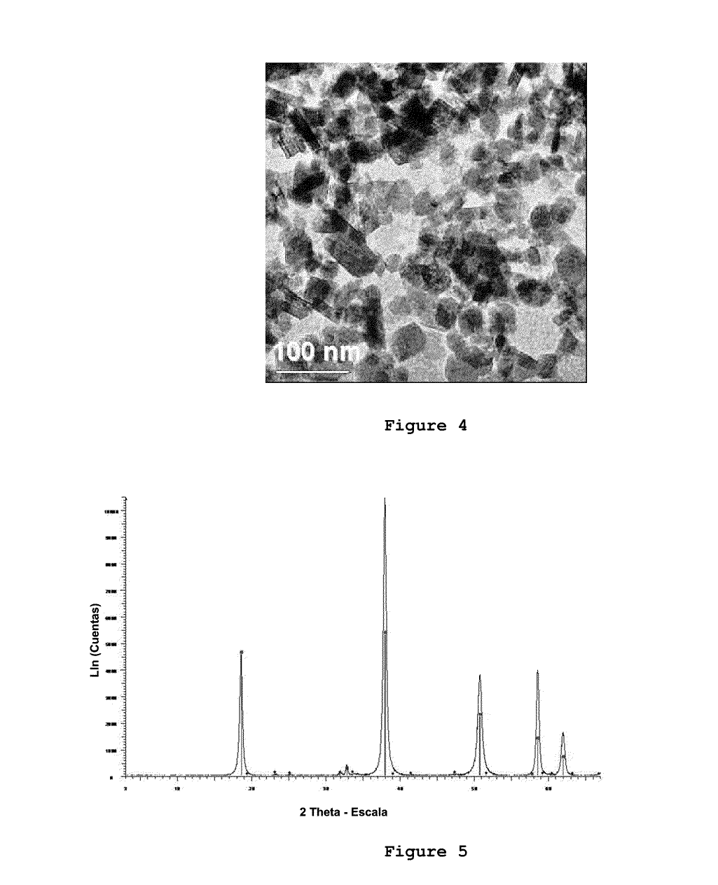

The FIG. 4 is a micrography of nanometric monodispersed magnesium hydroxide with sizes that range from 20 to 50 nm, measured using a Transmission Electron Microscope, the sample was prepared using the procedure described in the present invention in a (semi-industrial) pilot plant with capacity of 1.0 Tons of nanometric magnesium hydroxide per day.

The FIG. 5 is a diffractogram of magnesium hydroxide obtained by using a BRUKER D8 Advance x ray diffractometer, through the procedure described in the present invention. The Rietveld method calculates the crystal size taking as base the width and profile of diffractogram peaks.

The previously mentioned description of the process of this invention, reflects the necessary stages to assure that the obtained product reaches the characteristics of homogeneity, stability, monodispersity and other characteristics of magnesium hydroxide nanoparticles that have already been described, and furthermore, includes preferred modes of operating conditions, and other parameters; however, said description and the attached figures have to be considered as a representation of the process and product, more so than boundaries within themselves. For a person knowledgeable in this subject, it will be evident that new variations can be introduced when performing the invention with different equipment and raw materials normally available, but such variations cannot be considered out of scope of this invention, which is determined by following claims.

Once the invention has been described, that which is considered new and thus claimed as its property is:

1. Process for the production of nanometric, monodisperse and stable Mg(OH)2, which is constituted by the following stages:
a. to blend an aqueous magnesium solution and an aqueous alkaline solution,
b. to stabilize the blended product by adding a dilutant,
c. to mature the stabilized product,
d. to clean the matured product to obtain magnesium hydroxide particles,
The process is characterized because of:
i) the aqueous magnesium solution contains from 0.01% to 10% weight of dissolved magnesium, a surfactant and an organic acid,
ii) the aqueous alkaline solution has a concentration less than or equal to 50% of the weight of the alkali and a dispersant
iii) The diluted aqueous solution contains water and a dispersant
iv) The reaction stage is realized in two stages: micro mixing and stabilization
v) During maturing stage, the active points of the particles and the crystals obtained are deactivated
vi) In the washing stage the purity and the concentration of the magnesium hydroxide is controlled.

2. The process to obtain nanometric, monodisperse and stable Mg(OH)2, according to the first claim is characterized by the magnesium solution that is prepared from a combination of magnesium that is selected from the group that includes chlorides, sulfates, acetates, oxides, carbonates, and other compounds or mixtures of the same.

3. The production process to create Mg(OH)2, according to the first claim, is characterized by the fact that the surfactant is selected from a group that includes nonylphenol, alkyl aryl sodium sulfate, and lauryl sodium sulfate.

4. The process to obtain Mg(OH)2, according to the third claim, can be characterized by the fact that the surfactant of the aqueous solution of magnesium is found in a proportion that ranges from 0.01% to 10% and is preferable 2%, based on the weight of the precipitated magnesium hydroxide

5. The production process for Mg(OH)2, according to the first claim, is characterized by the organic acid used in the magnesium solution is selected from the group that includes: succinic, ascorbic, oxalic, adipic, tartaric, citric, diglycolic, salcylic and glutaric acid

6. According to the first claim, the process to obtain Mg(OH)2, is characterized because the alkali used to produce the alkaline solution is selected from the group that includes: sodium carbonate, potassium carbonate, sodium hydroxide, potassium hydroxide, ammonium and ammoniac solutions.

7. The process to obtain Mg(OH)2, according to the sixth claim, can be characterized by the fact that the aqueous alkaline solution maintains a pH of 8.5 or greater during the reaction.

8. According to the first claim, the process to obtain Mg(OH)2, is characterized because the dispersant to produce the alkaline solution is a dispersant with a base of a polyacrylate acid or salts there of derived.

9. The process to obtain Mg(OH)2, according to the eighth claim, can be characterized by the fact that the dispersant in an aqueous alkaline solution is found in a proportion that ranges from 0.01% to 10% based on the weight of the precipitated magnesium hydroxide.

10. As per the first claim, the process to obtain Mg(OH)2, is characterized by the diluted alkaline solution contains water and a dispersant with a base of a polyacrylate acid or salts there of derived, up to a 10% of the weight of the precipitated magnesium hydroxide.

11. The production process of Mg(OH)2, according to the first claim, is characterized by the fact that magnesium and alkaline solutions are blended by vigorous agitation, in a turbulent pattern with the NRe greater than or equal to 3,000, guarantying the micro blending.

12. According to the first claim, the process to obtain nanometric, monodisperse and stable Mg(OH)2, is characterized by the fact that the proportion of the mixture between the magnesium and the alkali is at a stoichiometric level.

13. The production process of Mg(OH)2, according to the first claim, is characterized by the fact that the proportion of the mixture between the magnesium and the alkali is not at a stoichiometric level, with from 20% to 50% in excess of the other, either of the respective parts of the reaction can have the excess in respect to the stoichiometric quantity.

14. The production process of Mg(OH)2, according to the thirteenth claim, is characterized by the fact that the proportion of the mixture between the magnesium and the alkali is with excess of the alkali in respect to the stoichiometric level, preferably in 30% with respect to the stoichiometric quantity.

15. The production process of Mg(OH)2, according to the first claim, is characterized by the fact that the time that the mixture remains in the micro mixing zone is up to 3 minutes and, preferably less than one minute.

16. The production process of Mg(OH)2, according to the first claim, is characterized by the fact that the product from the micro mixing zone is taking to the stabilization zone where a dilutant is added to it.

17. The production process of Mg(OH)2, according to the first claim, is characterized by the fact that in the stabilization zone homogenous mixing conditions prevail.

18. The production process of Mg(OH)2, according to the seventeenth claim, is characterized by the fact that the time in the stabilizing zone ranges from 5 to 30 minutes, and preferably between 5 and 10 minutes.

19. The production process of Mg(OH)2, according to the first claim, is characterized by the fact that the already stabilized product of the reaction is submitted to a stage of maturation with mechanical chemical conditioning.

20. The production process of Mg(OH)2, according to the first claim, is characterized because in order to mature, the product is subjected to ultrasound application, preferably that has to range from 20 to 45 kHz.

21. The production process of Mg(OH)2, according to the first claim, is characterized by the fact that the time in the maturation stage ranges from between 15 and 60 minutes and, preferably, around 15 minutes.

22. The production process of Mg(OH)2, according to the first claim, is characterized by the need to maintain the temperature between 60 to 80° C. during the maturing stage in order to achieve product maturation

23. The production process of Mg(OH)2, according to the first claim, is characterized by the fact that in the washing stage magnesium hydroxide particles are purified and the paste obtained has a concentration of less than or equal to 60% of the weight of the solid.

24. The production process of Mg(OH)2, according to the first claim, is characterized by the fact that the washing process can be repeated in as many cycles as needed to achieve the purity that is needed.

25. The production process of Mg(OH)2, according to the first claim, is characterized by the fact that the process is realized in batches.

26. According to the first claim, the process to obtain nanometric, monodisperse and stable Mg(OH)2, is characterized by the fact that it is performed in a continuous pattern process.

27. The production process of Mg(OH)2, according to the first claim, is characterized by the fact that the reaction of the formation of the product of the agitation in the micro mixing zone is preferably turbulent with the NRe greater than or equal to 3,000.

28. A magnesium hydroxide paste obtained according to the process described in the first claim, can be characterized by the fact that it is nanometric, monodispersed and stable in concentrations up to 60% of the weight.

29. A magnesium hydroxide paste obtained according to the process described on claim 13, can be characterized by the fact that average size of a magnesium hydroxide particle (D50) ranges from 90 to 110 nm, and by at least 90% of the particles having a size greater than (D10) 20 nm, and by at least 90% of the particles having a size of less than (D90) 160 nm.

30. A magnesium hydroxide paste obtained according to the process described in the first claim, can be characterized by the fact that the mentioned paste is stable for periods of greater than 12 month without the need of mechanical treatment.
